(19) United States
(12) Patent Application Publication
(10) Pub. No.: US 2026/0236325 A1
(43) Pub. Date: Aug. 13, 2026

(54) HYBRID INFERENCING USING AN ARTIFICIAL INTELLIGENCE OFFLOAD DIE IN A SYSTEM-IN-A-PACKAGE

(71) Applicant: Microsoft Technology Licensing, LLC, Redmond, WA (US)

(72) Inventors: Zhuo RUAN, San Jose, CA (US); Edward GAMSARAGAN, Kirkland, WA (US); Arijit CHATTOPADHYAY, Seattle, WA (US); Simanti LAHIRI, Phoenix, AZ (US)

(21) Appl. No.: 19/048,018

(22) Filed: Feb. 7, 2025

(51) Int. Cl. G06F 9/52; G06F 15/173; G06N 5/04

(52) U.S. Cl. CPC G06F 9/52; G06F 15/17331; G06F 2209/522; G06N 5/04

(57) ABSTRACT

A method implemented in an artificial intelligence (AI) offload die within a system-in-a-package involves hybrid inferencing of an AI model by a remote computing system and a compute die in the system-in-a-package. The method includes identifying a portion of the AI model for use by the compute die, utilizing a network controller in the AI offload die to fetch this portion from the remote computing system, and communicating it to the compute die. Additionally, the network controller in the AI offload die synchronizes AI model inferencing state between the compute die and the remote computing system, ensuring coordinated hybrid AI model inferencing. This approach facilitates efficient distribution and execution of AI tasks between the compute die and the remote computing system, enhancing computational performance and resource utilization.

### BACKGROUND

Large language models (LLMs) have emerged as transformative tools in artificial intelligence, driving advances in natural language processing tasks such as text generation, summarization, translation, question-answering, image generation, and video generation. These models, built using deep learning architectures like transformers, consist of massive numbers of parameters, often ranging from billions to trillions. Parameters represent learned weights and biases that enable the model to process and predict text sequences. As LLM sizes increase to achieve higher accuracy and more complex reasoning capabilities, the storage and access requirements for these parameters grow proportionally, introducing significant demands on memory systems during inference.

Inference in LLMs involves generating output tokens, such as words or sub-words, based on input tokens provided by the user. This process loads the LLM's parameters into memory and repeatedly accesses them across multiple computational steps. In addition to parameter storage, inference generates a large volume of intermediate data, commonly referred to as activations, which represent the internal states of the model during computation. These activations are often retained for subsequent processing or reused across layers of the model. Both the sheer size of the parameters and the growing complexity of activations contribute to substantial memory requirements, both in terms of capacity (the total amount of data that must be stored) and bandwidth (the rate at which data must be accessed and transferred).

In recent years, the demand for efficient LLM inferencing has led to the development of various methods and systems to enhance the performance of LLMs. Traditional approaches have often relied on centralized computing systems where LLMs are processed entirely on remote servers. This method, while effective in leveraging powerful centralized computational resources, can suffer from latency issues due to the time required to transmit data between the local device and the remote server. Additionally, the reliance on constant connectivity to the remote server can be a limitation in scenarios where network stability is a concern.

Another approach uses on-device LLM processing, where LLM inferencing is executed directly on local hardware, such as smartphones, laptops, desktops, or other edge devices. This method reduces latency and dependency on network connectivity, as the data does not need to be sent to a remote server for processing. However, on-device processing is often considerably constrained by the limited computational resources, memory resources, and power availability of the local hardware, which can restrict the complexity and size of the LLMs that can be effectively utilized.

The subject matter claimed herein is not limited to embodiments that solve any disadvantages or that operate only in environments such as those described supra. Instead, this background is only provided to illustrate one example technology area where some embodiments described herein may be practiced.

### SUMMARY

In some aspects, the techniques described herein relate to a method implemented in an artificial intelligence (AI) offload die that includes a network controller, and that is communicatively coupled with a compute die in a system-in-a-package, the method including, during a hybrid inferencing of an AI model by a remote computing system and the compute die: identifying a portion of the AI model for use by the compute die; using the network controller, fetching the portion of the AI model from the remote computing system; communicating the portion of the AI model to the compute die; and using the network controller, synchronizing AI model inferencing state between the compute die and the remote computing system.

In some aspects, the techniques described herein relate to an AI offload die including: a network controller; and an AI offloading engine configured, during a hybrid inferencing of an AI model by a remote computing system and a compute die, to: identify a portion of the AI model for use by the compute die; using the network controller, fetch the portion of the AI model from the remote computing system; communicate the portion of the AI model to the compute die; and using the network controller, synchronize AI model inferencing state between the compute die and the remote computing system.

In some aspects, the techniques described herein relate to a system-in-a-package, including: a compute die including a processor system and an AI accelerator; a memory; and an AI offload die, including: a network controller; and an AI offloading engine configured, during a hybrid inferencing of an AI model by a remote computing system and the compute die, to: identify a portion of the AI model for use by the compute die; using the network controller, fetch the portion of the AI model from the remote computing system; communicate the portion of the AI model to the compute die; and using the network controller, synchronize AI model inferencing state between the compute die and the remote computing system.

This Summary introduces a selection of concepts in a simplified form that are further described below in the Detailed Description. This Summary is not intended to identify key features or essential features of the claimed subject matter, nor is it intended to be used to determine the scope of the claimed subject matter.

### BRIEF DESCRIPTION OF THE DRAWINGS

To describe how the advantages of the systems and methods described herein can be obtained, a more particular description of the embodiments briefly described supra is rendered by reference to specific embodiments thereof, which are illustrated in the appended drawings. These drawings depict only typical embodiments of the systems and methods described herein and are not, therefore, to be considered to be limiting in their scope. Systems and methods are described and explained with additional specificity and detail through the use of the accompanying drawings, in which:

FIG. 1 illustrates an example of a computer architecture for the hybrid execution of an artificial intelligence (AI) model using an AI offload die;

FIG. 2 illustrates an example of components of an AI offloading engine of an AI offload die;

FIG. 3 illustrates an example of synchronizing AI model parameters and activations for hybrid model inference; and

FIG. 4 illustrates a flow chart of an example of a method for hybrid AI offloading by an AI offload die during hybrid inferencing of an AI model by a remote computing system and a compute die.

### DETAILED DESCRIPTION

Hybrid inferencing has recently emerged as a promising solution for enhancing the performance of large language models (LLMs), combining the strengths of both centralized and on-device processing. In this approach, portions of the LLM are processed locally, while other parts are processed at a remote server. This method aims to optimize performance by balancing the computational load between local and remote resources. However, existing hybrid inferencing techniques often face challenges in efficiently managing the synchronization of LLM states between the local and remote systems, as well as in dynamically determining which portions of the LLM should be processed locally versus remotely.

At least some embodiments described are directed to an artificial intelligence (AI) offload die (e.g., an integrated circuit, such as a chiplet) and methods implemented thereon for managing hybrid processing of an AI model (e.g., inferencing of an LLM) across an edge device (e.g., smartphone, laptop computer, desktop computer) and a remote computing system (e.g., a remote server). In these embodiments, the AI offload die manages the dynamic streaming of AI model content (e.g., model weights/parameters, model inferencing state) between a compute die (e.g., comprising a central processing unit and an AI accelerator) and a remote computing system. In embodiments, the AI offload die includes a network controller that communicates directly with the remote computing system separately from the compute die. During hybrid inferencing of an AI model by a remote computing system and the compute die, the AI offload die dynamically identifies portion(s) of the AI model (e.g., model weights/parameters) for use by the compute die, fetches those portion(s) of the AI model from the remote computing system, and communicates them to the compute die. Additionally, the AI offload die synchronizes AI model inferencing state between the compute die and the remote computing system.

These embodiments ensure coordinated hybrid AI model inferencing by a compute die and a remote computing system, facilitating efficient distribution and execution of AI tasks between the compute die and the remote computing system, thereby enhancing computational performance and resource utilization. By communicating with the remote computing system directly, the AI offload die frees the compute die from such tasks, enabling the compute die to handle AI model processing more efficiently than it would be able to without the AI offload die.

Notably, while the disclosure has referred primarily to LLMs due to their sheer size and the challenges that size presents, the principles described herein are more broadly applicable to various AI model types. As such, the remaining disclosure refers primarily to AI models and AI model processing rather than the more specific application of LLMs and LLM inferencing.

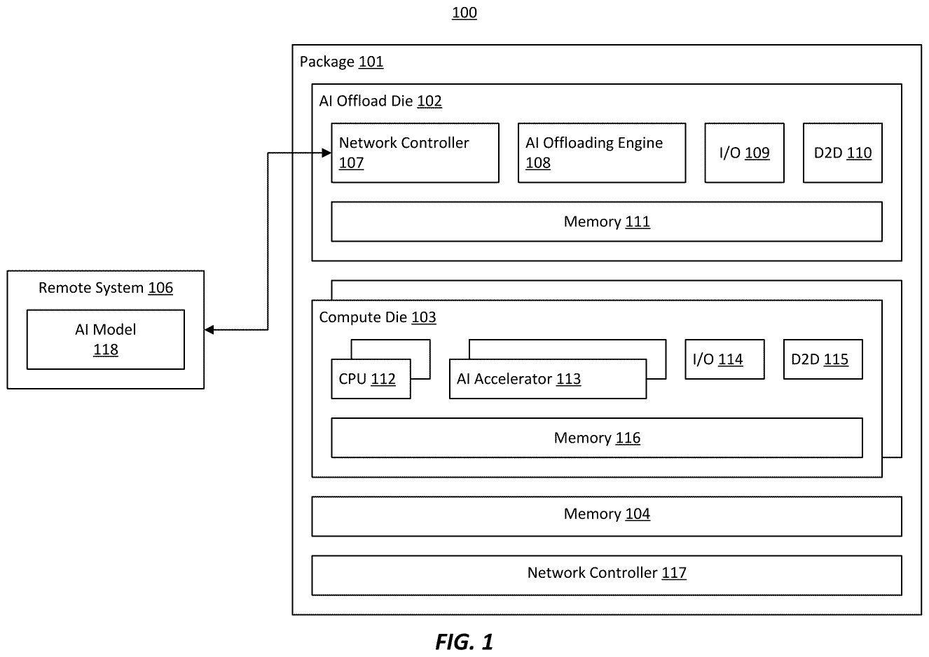

FIG. 1 illustrates an example of a computer architecture 100 for the hybrid execution of an AI model using an AI offload die. Referring to FIG. 1, computer architecture 100 includes a package 101 (e.g., a system-in-a-package (SiP)) that includes an AI offload die 102 and a compute die 103 (or, as indicated, a plurality of compute dies) such as a system-on-a-chip (SoC) and a memory 104 (e.g., a system memory). In some embodiments, package 101 includes a network controller 117 utilized by the compute die 103. In other embodiments, the network controller 117 is part of the compute die 103. The AI offload die 102 provides enhanced AI processing capabilities to support and complement hybrid execution (e.g., inference) of an AI model 118 (e.g., an LLM) across a remote system 106 and the compute die 103.

The compute die 103 includes a central processing unit (CPU) 112 (or a plurality of CPUs), AI accelerator 113 (or a plurality of AI accelerators), a memory 104 (e.g., a local cache memory), general input out/output (I/O) hardware 114 (e.g., as a peripheral component interconnect express (PCIe) bus interface), and a die-to-die (D2D) interface, D2D interface 115. In various examples, the AI accelerator 113 comprises a neural processing unit (NPU), a tensor processing unit (TPU), a graphics processing unit (GPU), or combinations thereof. The components of the compute die 103 work in tandem to execute various computational tasks, including general-purpose operations and specialized AI-driven processes. For example, compute die 103 may execute an operating system (OS) and other applications primarily at the CPU 112 and may execute AI inferencing tasks primarily at the AI accelerator 113.

The AI offload die 102 includes a network controller 107, which is independent of network controller 117, an AI offloading engine 108, I/O hardware 109, a D2D interface 110, and a memory 111 (e.g., a local cache memory). In some examples, the AI offload die 102 and the compute die 103 communicate, at least in part, using D2D communications (e.g., D2D interface 110, D2D interface 115).

Using the network controller 107, the AI offload die 102 communicates directly with the remote system 106 to communicate data (e.g., model parameters, model activations) relevant to a hybrid processing of AI model 118 by compute die 103 and remote system 106. In the embodiments described herein, the AI offload die 102 communicating directly with the remote system 106 means that AI offload die 102 uses the network controller 107 to communicate with the remote system 106 independently of the compute die 103. This means, for example, that the AI offload die 102 communicates model parameters, model activations, etc., without the involvement of an OS executing at the compute die 103, and without requiring any participation by the CPU 112, and/or without the involvement of the network controller 117. By handling communications with remote system 106 independently of compute die 103, the AI offload die 102 can reduce the latency of the communication of model data, such as model parameters and model activations, compared to situations (e.g., in the absence of AI offload die 102) in which the compute die 103 would need to communicate such data itself. For example, AI offload die 102 can operate an optimized network stack solely focused on the communication of model data, whereas the compute die 103 would operate a more general network stack used for general data communications by all applications executing at compute die 103. In some embodiments, the AI offload die 102 further reduces the latency of the communication of model data by utilizing remote direct memory access (RDMA) technology to communicate model data directly between memory locations in package 101 (e.g., within one or more of memory 111, of memory 104, or of memory 116) and memory locations in remote system 106.

The AI offloading engine 108 comprises circuitry, microcode, firmware, and the like, implementing an AI offloading state machine. In some implementations, the AI offloading engine 108 comprises an AI compute core that predicts (using, e.g., vector operations and tensor operations) portion(s) (e.g., subsets of mode. parameters) of AI model 118 to run on the AI accelerator 113 at the compute die 103, and that aligns model contexts/tokens (e.g., activations) between the compute die 103 and the remote system 106. In embodiments, the AI offloading engine 108 allocates data buffers (e.g., within one or more of memory 111, memory 104, or memory 116), generates/dispatches RDMA commands to initiate data transfers, and handles the roll-back of speculative inference of the AI accelerator 113 if a context/token misalignment is detected at the remote system 106.

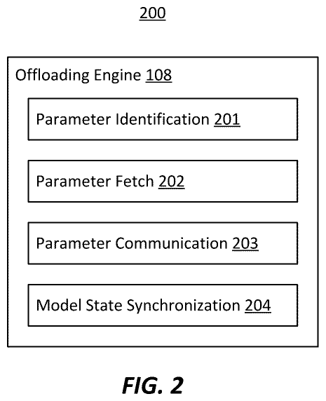

FIG. 2 illustrates an example 200 of components of the AI offloading engine 108 of FIG. 1. Each component of the AI offloading engine 108 depicted in FIG. 2 represents various functionalities that the AI offloading engine 108 may implement under the embodiments described herein. These components—including their identity and arrangement—are presented merely as an aid in describing example embodiments of the AI offloading engine 108.

A parameter identification component 201 predicts which portion(s) of AI model 118 will be needed for processing by AI accelerator 113 at compute die 103. A parameter fetch component 202 fetches the portion(s) of AI model 118 predicted by the parameter identification component 201 to be needed by AI accelerator 113 at compute die 103. After fetching by the parameter fetch component 202, the parameter communication component 203 communicates those portion(s) to the AI accelerator 113 at compute die 103. In some embodiments, communication by parameter communication component 203 is inherent in the operation of parameter fetch component 202. For example, the parameter fetch component 202 may use RDMA to fetch data directly into memory accessible by AI accelerator 113, such as memory 104 or memory 116. A model state synchronization component 204 synchronizes AI model execution state, such as contexts/tokens (e.g., activations) between remote system 106 and compute die 103. Thus, model state synchronization component 204 ensures that the execution of AI model 118 at remote system 106 is kept in sync with the execution of AI model 118 at compute die 103. Similar to parameter fetch component 202, in embodiments, the model state synchronization component 204 may use RDMA to communicate data directly between specific memory locations at remote system 106 and specific memory locations at package 101.

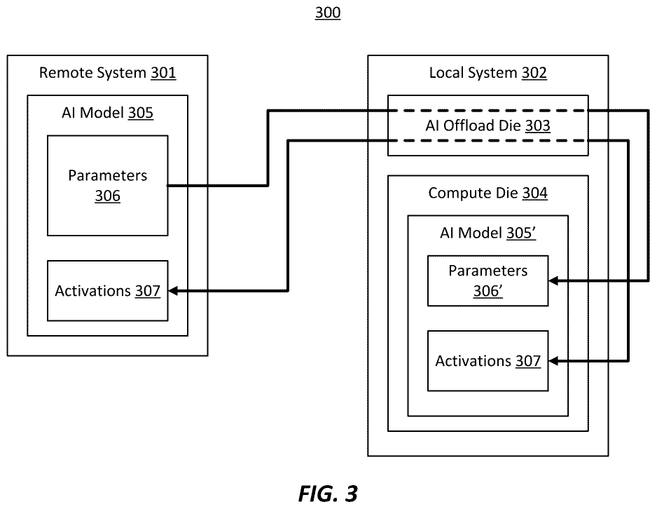

FIG. 3 illustrates an example 300 of synchronizing AI model parameters and activations for hybrid model inference. In example 300, a remote system 301 and a local system 302 cooperate in the hybrid inference of an AI model. Local system 302 includes an AI offload die 303 (e.g., AI offload die 102) and a compute die 304 (e.g., compute die 103). In hybrid AI model inferencing, AI model 305′ instantiated on the local system 302 represents a subset of AI model 305 instantiated on the remote system 301. In particular, AI model 305′ has only a subset of the parameters of AI model 305′ (e.g., parameters 306′ are smaller than parameters 306 in FIG. 3). In some embodiments, the AI model 305′ contains only those parameters needed for the computation delegated to the local system 302, as determined dynamically by the AI offloading engine 108 (e.g., parameter identification component 201). Fetching of a subset of parameters of AI model 305 is indicated in FIG. 3 by a single-directional arrow extending from parameters 306 in AI model 305, through AI offload die 303, and ending at parameters 306′ in AI model 305′.

The AI offloading engine 108 (e.g., model state synchronization component 204) continually synchronizes activations 307 (e.g., the dynamic computational state of the hybrid AI model during inference) between the local system 302 and the remote system 301. This synchronization ensures that despite the partial nature of AI model 305′, the overall inferencing state remains consistent and coherent across both systems. Such alignment enables the seamless integration of results and the maintenance of inference accuracy while distributing computational load efficiently across the hybrid setup.

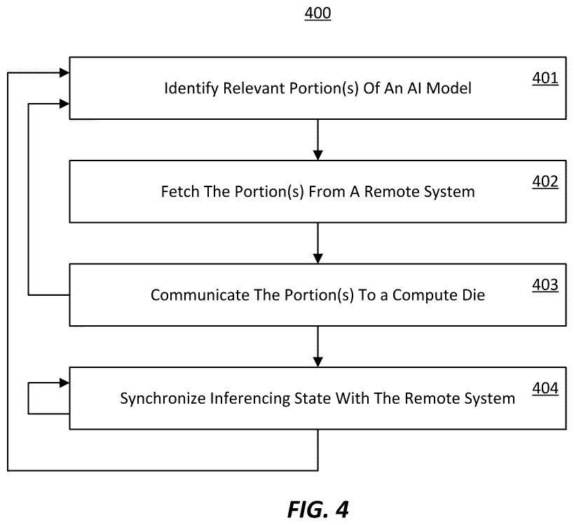

Embodiments are now described in connection with FIG. 4, which illustrates a flow chart of an example method 400 for hybrid AI offloading by an AI offload die during hybrid inferencing of an AI model by a remote computing system and a compute die. In embodiments, method 400 is implemented in an AI offload die (e.g., AI offload die 102) that comprises a network controller (e.g., network controller 107) and that is communicatively coupled with a compute die (e.g., compute die 103) in a SiP (e.g., package 101). In embodiments of method 400, the compute die comprises a processor system (e.g., CPU 112) and an AI accelerator (e.g., AI accelerator 113), such as an NPU, a TPU, and/or a GPU.

The following discussion now refers to a method and method acts. Although the method acts are discussed in specific orders or illustrated in a flow chart as occurring in a particular order, no order is required unless expressly stated or required because an act depends on another act being completed before the act is performed.

Referring to FIG. 4, in embodiments, method 400 comprises act 401 of identifying relevant portion(s) of an AI model. In some embodiments, act 401 comprises identifying a portion of the AI model for use by the compute die. For example, in the environment of example 300, the parameter identification component 201, operating at AI offload die 303, identifies a subset of parameters 306 that are predicted to be needed for the execution of AI model 305′ at compute die 304.

Method 400 also comprises act 402 of fetching the portion(s) from a remote system. In some embodiments, act 402 comprises fetching the portion of the AI model from the remote computing system using the network controller. For example, parameter fetch component 202 uses a network controller at AI offload die 303 (e.g., network controller 107) to fetch the identified subset of parameters 306 from the remote system 301. This is indicated in FIG. 3 by an arrow extending from parameters 306 to AI offload die 303. Thus, in embodiments, the network controller enables the AI offload die to send and receive data independently of the compute die(s). In some embodiments, the network controller used in act 402 is distinct from a network controller used by compute die 304. In an example, the network controller is a first network controller (e.g., network controller 107, AI offload die 102), the SiP or the compute die comprises a second network controller (e.g., network controller 117, package 101), the first network controller is inaccessible by an OS executing at the compute die, and the second network controller is accessible by the OS executing at the compute die. In some examples, the network controller communicates with the remote computing system using RDMA.

Method 400 also comprises act 403 of communicating the portion(s) to a compute die. In some embodiments, act 403 comprises communicating the portion of the AI model to the compute die. For example, the parameter communication component 203 communicates the fetched subset of parameters 306 to compute die 304. This is indicated in FIG. 3 by an arrow extending from AI offload die 303 to parameters 306′.

In act 402 and/or act 403, the AI offloading engine 108 can place model data in memory at AI offload die 303 (e.g., memory 111, AI offload die 102), in memory at compute die 304 (e.g., memory 116, compute die 103), and/or in memory shared by AI offload die 303 and compute die 304 (e.g., memory 104, package 101). Thus, in embodiments, the network controller fetches the portion of the AI model into at least one of a first memory in the AI offload die, a second memory in the SiP that is separate from the AI offload die, or a third memory in the compute die.

Method 400 also comprises act 404 of synchronizing inferencing state with the remote system. In some embodiments, act 404 comprises, using the network controller, synchronizing AI model inferencing state between the compute die and the remote computing system. For example, model state synchronization component 204 synchronizes activations 307 between AI model 305 at remote system 301 and AI model 305′ at compute die 304. This is indicated in FIG. 3 by a double-ended arrow extending between activations 307 at AI model 305 and activations 307 at AI model 305′, which passes through AI offload die 303. In one example, synchronizing the AI model inferencing state includes aligning a token between the compute die and the remote computing system. For instance, AI model 305 may represent each token differently than AI model 305′ (e.g., using different embeddings, or vector formats). A token generated by AI model 305′ is at first converted to a token representation that can be consumed by AI model 305. AI model 305 then checks whether this converted token meets the context expectation; if the converted token does not, a token misalignment has occurred. When a token misalignment is discovered by AI model 305, it rolls back the speculative execution and regenerates the token.

Notably, as indicated in FIG. 1, an AI offload die may operate on behalf of a plurality of compute dies, each of which may contain a plurality of CPUs and/or a plurality of AI accelerators. Thus, in embodiments, the AI offload die is communicatively coupled with a plurality of compute dies in the SiP and method 400 also comprises identifying a plurality of portions of the AI model, each portion corresponding to one the plurality of compute dies; using the network controller, fetching the plurality of portions of the AI model from the remote computing system; communicating each portion of the AI model to its corresponding compute die of the plurality of compute dies; and using the network controller, synchronizing the AI model inferencing state between the plurality of compute dies and the remote computing system.

Notably, method 400 operates to continually fetch portions of a remote AI model needed for local execution, and to synchronize model state. For example, an arrow extending from act 403 to act 401 and an arrow extending from act 404 to act 401 indicate that the AI offloading engine 108 can initiate a new prediction and fetching of AI model portion(s) after completing a prior fetch and/or after completing a synchronization. Additionally, an arrow looping from act 404 into itself indicates that model state synchronization can operate continuously.

Accordingly, a method implemented in an AI offload die within a SiP involves hybrid inferencing of an AI model by a remote computing system and a compute die in the SiP. The method includes identifying a portion of the AI model for use by the compute die, utilizing a network controller in the AI offload die to fetch this portion from the remote computing system, and communicating it to the compute die. Additionally, the network controller in the AI offload die synchronizes AI model inferencing state between the compute die and the remote computing system, ensuring coordinated hybrid AI model inferencing.

Additionally, an AI offload die facilitates hybrid inferencing of an AI model by a remote computing system and a compute die. The AI offload die identifies a portion of the AI model for use by the compute die, utilizes a network controller in the AI offload die to fetch this portion from the remote computing system, and communicates it to the compute die. Additionally, the AI offload die uses the network controller to synchronize AI model inferencing state between the compute die and the remote computing system, ensuring coordinated hybrid AI model inferencing.

The described SiP architecture provides significant advantages in enabling hybrid inferencing for AI models by integrating a main compute die, and an AI offload die with specialized AI offloading capabilities. This modular approach ensures scalability and cost-effectiveness by allowing the base compute die to remain unmodified while incorporating advanced neural processing capabilities through a secondary die. An AI offload die, featuring direct network access and RDMA functionality, eliminates reliance on the OS for managing data transfers, reducing latency and CPU overhead. This configuration ensures efficient communication between local AI accelerators and remote cloud systems, facilitating low-latency hybrid AI processing.

The design minimizes production complexity and time-to-market by decoupling the AI accelerator's growth from the base compute die, enabling independent scaling of the AI accelerator. Using chiplet technology allows flexible packaging configurations, supporting stacked and side-by-side arrangements, which can be adapted for diverse device requirements. Additionally, including in-package memory ensures high bandwidth and energy-efficient data handling for demanding AI workloads. These innovations collectively establish a highly efficient framework for hybrid AI applications, balancing local processing and cloud-assisted computation to achieve improved performance, security, and manufacturing optimization.

Alternatively or in addition to the other examples described herein, examples include any combination of the following:

### Clause 1

A method implemented in an artificial intelligence (AI) offload die that comprises a network controller, and that is communicatively coupled with a compute die in a system-in-a-package, the method comprising, during a hybrid inferencing of an AI model by a remote computing system and the compute die: identifying a portion of the AI model for use by the compute die; using the network controller, fetching the portion of the AI model from the remote computing system; communicating the portion of the AI model to the compute die; and using the network controller, synchronizing AI model inferencing state between the compute die and the remote computing system.

### Clause 2

The method of clause 1, wherein the network controller communicates with the remote computing system using remote direct access memory (RDMA).

### Clause 3

The method of any of clause 1 or claim 2, wherein the network controller fetches the portion of the AI model into at least one of a first memory in the AI offload die, a second memory in the system-in-a-package that is separate from the AI offload die, or a third memory in the compute die. In one variation, the network controller fetches the portion of the AI model into the first memory in the AI offload die and the second memory in a system-in-a-package. In another variation, the network controller fetches the portion of the AI model into the first memory in the AI offload die and the third memory in the compute die. In another variation, the network controller fetches the portion of the AI model into the second memory in a system-in-a-package and the third memory in the compute die. In another variation, the network controller fetches the portion of the AI model into each of the first memory in the AI offload die, the second memory in a system-in-a-package, and the third memory in the compute die.

### Clause 4

The method of any of clause 1 to claim 3, wherein, the network controller is a first network controller; the system-in-a-package or the compute die comprises a second network controller; the first network controller is inaccessible by an operating system (OS) executing at the compute die; and the second network controller is accessible by the OS executing at the compute die.

### Clause 5

The method of any of clause 1 to claim 4, wherein: the AI offload die is communicatively coupled with a plurality of compute dies in the system-in-a-package; and the method comprises: identifying a plurality of portions of the AI model, each portion corresponding to one the plurality of compute dies; using the network controller, fetching the plurality of portions of the AI model from the remote computing system; communicating each portion of the AI model to its corresponding compute die of the plurality of compute dies; and using the network controller, synchronizing the AI model inferencing state between the plurality of compute dies and the remote computing system.

### Clause 6

The method of any of clause 1 to claim 5, wherein synchronizing the AI model inferencing state includes one or more of, aligning a token between the compute die and the remote computing system, or initiating a roll-back of a speculative inference at the compute die based on a token misalignment at the remote computing system.

### Clause 7

An artificial intelligence (AI) offload die comprising: a network controller; and an AI offloading engine configured, during a hybrid inferencing of an AI model by a remote computing system and a compute die, to: identify a portion of the AI model for use by the compute die; using the network controller, fetch the portion of the AI model from the remote computing system; communicate the portion of the AI model to the compute die; and using the network controller, synchronize AI model inferencing state between the compute die and the remote computing system.

### Clause 8

The AI offload die of clause 7, wherein the network controller communicates with the remote computing system using remote direct access memory (RDMA).

### Clause 9

The AI offload die of any of clause 7 to claim 8, wherein the network controller fetches the portion of the AI model into at least one of a first memory in the AI offload die, a second memory in a system-in-a-package that is separate from the AI offload die, or a third memory in the compute die. In one variation, the network controller fetches the portion of the AI model into the first memory in the AI offload die and the second memory in a system-in-a-package. In another variation, the network controller fetches the portion of the AI model into the first memory in the AI offload die and the third memory in the compute die. In another variation, the network controller fetches the portion of the AI model into the second memory in a system-in-a-package and the third memory in the compute die. In another variation, the network controller fetches the portion of the AI model into each of the first memory in the AI offload die, the second memory in a system-in-a-package, and the third memory in the compute die.

### Clause 10

The AI offload die of any of clause 7 to claim 9, wherein: the network controller is a first network controller; the compute die or a system-in-a-package comprises a second network controller; the first network controller is inaccessible by an operating system (OS) executing at the compute die; and the second network controller is accessible by the OS executing at the compute die.

### Clause 11

The AI offload die of any of clause 7 to claim 10, wherein the AI offload die is in a system-in-a-package that also comprises the compute die.

### Clause 12

The AI offload die of clause 11, wherein: the system-in-a-package comprises a plurality of compute dies; and the AI offloading engine, identifies a plurality of portions of the AI model, each portion corresponding to one the plurality of compute dies; using the network controller, fetches the plurality of portions of the AI model from the remote computing system; communicates each portion of the AI model to its corresponding compute die of the plurality of compute dies; and using the network controller, synchronizes the AI model inferencing state between the plurality of compute dies and the remote computing system.

### Clause 13

The AI offload die of any of clause 7 to claim 12, wherein synchronizing the AI model inferencing state includes one or more of, aligning a token between the compute die and the remote computing system, or initiating a roll-back of a speculative inference at the compute die based on a token misalignment at the remote computing system.

### Clause 14

A system-in-a-package, comprising: a compute die comprising a processor system and an artificial intelligence (AI) accelerator; a memory; and an AI offload die, comprising: a network controller; and an AI offloading engine configured, during a hybrid inferencing of an AI model by a remote computing system and the compute die, to: identify a portion of the AI model for use by the compute die; using the network controller, fetch the portion of the AI model from the remote computing system; communicate the portion of the AI model to the compute die; and using the network controller, synchronize AI model inferencing state between the compute die and the remote computing system.

### Clause 15

The system-in-a-package of clause 14, wherein the AI accelerator in the compute die is one of a neural processing unit (NPU), a tensor processing unit (TPU), or a graphics processing unit (GPU).

### Clause 16

The system-in-a-package of any of clause 14 to claim 15, wherein the network controller communicates with the remote computing system using remote direct access memory (RDMA).

### Clause 17

The system-in-a-package of any of clause 14 to claim 16, wherein the network controller fetches the portion of the AI model into at least one of a first memory in the AI offload die, a second memory in the system-in-a-package that is separate from the AI offload die, or a third memory in the compute die. In one variation, the network controller fetches the portion of the AI model into the first memory in the AI offload die and the second memory in a system-in-a-package. In another variation, the network controller fetches the portion of the AI model into the first memory in the AI offload die and the third memory in the compute die. In another variation, the network controller fetches the portion of the AI model into the second memory in a system-in-a-package and the third memory in the compute die. In another variation, the network controller fetches the portion of the AI model into each of the first memory in the AI offload die, the second memory in a system-in-a-package, and the third memory in the compute die.

### Clause 18

The system-in-a-package of any of clause 14 to claim 17, wherein, the network controller is a first network controller; the system-in-a-package or the compute die comprises a second network controller; the first network controller is inaccessible by an operating system (OS) executing at the compute die; and the second network controller is accessible by the OS executing at the compute die.

### Clause 19

The system-in-a-package of any of clause 14 to claim 18, wherein, the system-in-a-package comprises a plurality of compute dies; and the AI offloading engine, identifies a plurality of portions of the AI model, each portion corresponding to one the plurality of compute dies; using the network controller, fetches the plurality of portions of the AI model from the remote computing system; communicates each portion of the AI model to its corresponding compute die of the plurality of compute dies; and using the network controller, synchronizes the AI model inferencing state between the plurality of compute dies and the remote computing system.

### Clause 20

The system-in-a-package of any of clause 14 to claim 19, wherein synchronizing the AI model inferencing state includes one or more of, aligning a token between the compute die and the remote computing system, or initiating a roll-back of a speculative inference at the compute die based on a token misalignment at the remote computing system.

Embodiments of the disclosure comprise or utilize a special-purpose or general-purpose computer system that includes computer hardware, such as, for example, a processor system and system memory, as discussed in greater detail below. Embodiments within the scope of the present disclosure also include physical and other computer-readable media for carrying or storing computer-executable instructions and/or data structures. Such computer-readable media can be any available media accessible by a general-purpose or special-purpose computer system. Computer-readable media that store computer-executable instructions and/or data structures are computer storage media. Computer-readable media that carry computer-executable instructions and/or data structures are transmission media. Thus, embodiments of the disclosure can comprise at least two distinctly different kinds of computer-readable media: computer storage media and transmission media.

Computer storage media are physical storage media that store computer-executable instructions and/or data structures. Physical storage media include computer hardware, such as random access memory (RAM), read-only memory (ROM), electrically erasable programmable ROM (EEPROM), solid state drives (SSDs), flash memory, phase-change memory (PCM), optical disk storage, magnetic disk storage or other magnetic storage devices, or any other hardware storage device(s) which store program code in the form of computer-executable instructions or data structures, which can be accessed and executed by a general-purpose or special-purpose computer system to implement the disclosed functionality.

Transmission media include a network and/or data links that carry program code in the form of computer-executable instructions or data structures that are accessible by a general-purpose or special-purpose computer system. A “network” is defined as a data link that enables the transport of electronic data between computer systems and other electronic devices. When information is transferred or provided over a network or another communications connection (either hardwired, wireless, or a combination thereof) to a computer system, the computer system may view the connection as transmission media. The scope of computer-readable media includes combinations thereof.

Upon reaching various computer system components, program code in the form of computer-executable instructions or data structures can be transferred automatically from transmission media to computer storage media (or vice versa). For example, computer-executable instructions or data structures received over a network or data link can be buffered in RAM within a network interface module and eventually transferred to computer system RAM and/or less volatile computer storage media at a computer system. Thus, computer storage media can be included in computer system components that also utilize transmission media.

Computer-executable instructions comprise, for example, instructions and data which when executed at a processor system, cause a general-purpose computer system, a special-purpose computer system, or a special-purpose processing device to perform a function or group of functions. In embodiments, computer-executable instructions comprise binaries, intermediate format instructions (e.g., assembly language), or source code. In embodiments, a processor system comprises one or more central processing units (CPUs), one or more graphics processing units (GPUs), one or more neural processing units (NPUs), and the like.

In some embodiments, the disclosed systems and methods are practiced in network computing environments with many types of computer system configurations, including personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. In some embodiments, the disclosed systems and methods are practiced in distributed system environments where different computer systems, which are linked through a network (e.g., by hardwired data links, wireless data links, or by a combination of hardwired and wireless data links), both perform tasks. As such, in a distributed system environment, a computer system may include a plurality of constituent computer systems. Program modules may be located in local and remote memory storage devices in a distributed system environment.

In some embodiments, the disclosed systems and methods are practiced in a cloud computing environment. In some embodiments, cloud computing environments are distributed, although this is not required. When distributed, cloud computing environments may be distributed internally within an organization and/or have components possessed across multiple organizations. In this description and the following claims, “cloud computing” is a model for enabling on-demand network access to a shared pool of configurable computing resources (e.g., networks, servers, storage, applications, and services). A cloud computing model can be composed of various characteristics, such as on-demand self-service, broad network access, resource pooling, rapid elasticity, measured service, and so forth. A cloud computing model may also come in the form of various service models such as Software as a Service (SaaS), Platform as a Service (PaaS), Infrastructure as a Service (IaaS), etc. The cloud computing model may also be deployed using different deployment models such as private cloud, community cloud, public cloud, hybrid cloud, etc.

Some embodiments, such as a cloud computing environment, comprise a system with one or more hosts capable of running one or more virtual machines (VMs). During operation, VMs emulate an operational computing system, supporting an operating system (OS) and perhaps one or more other applications. In some embodiments, each host includes a hypervisor that emulates virtual resources for the VMs using physical resources that are abstracted from the view of the VMs. The hypervisor also provides proper isolation between the VMs. Thus, from the perspective of any given VM, the hypervisor provides the illusion that the VM is interfacing with a physical resource, even though the VM only interfaces with the appearance (e.g., a virtual resource) of a physical resource. Examples of physical resources include processing capacity, memory, disk space, network bandwidth, media drives, and so forth.

Although the subject matter has been described in language specific to structural features and/or methodological acts, it is to be understood that the subject matter defined in the appended claims is not necessarily limited to the described features or acts described supra or the order of the acts described supra. Rather, the described features and acts are disclosed as example forms of implementing the claims.

The present disclosure may be embodied in other specific forms without departing from its essential characteristics. The described embodiments are only illustrative and not restrictive. All changes that come within the meaning and range of equivalency of the claims are to be embraced within their scope.

When introducing elements in the appended claims, the articles “a,” “an,” “the,” and “said” are intended to mean there are one or more of the elements. The terms “comprising,” “including,” and “having” are intended to be inclusive and mean that there may be additional elements other than the listed elements. Unless otherwise specified, the terms “set,” “superset,” and “subset” are intended to exclude an empty set, and thus “set” is defined as a non-empty set, “superset” is defined as a non-empty superset, and “subset” is defined as a non-empty subset. Unless otherwise specified, the term “subset” excludes the entirety of its superset (i.e., the superset contains at least one item not included in the subset). Unless otherwise specified, a “superset” can include at least one additional element, and a “subset” can exclude at least one element.

What is claimed:

1. A method implemented in an artificial intelligence (AI) offload die that comprises a network controller, and that is communicatively coupled with a compute die in a system-in-a-package, the method comprising, during a hybrid inferencing of an AI model by a remote computing system and the compute die:
identifying a portion of the AI model for use by the compute die;
using the network controller, fetching the portion of the AI model from the remote computing system;
communicating the portion of the AI model to the compute die; and
using the network controller, synchronizing AI model inferencing state between the compute die and the remote computing system.

2. The method of claim 1, wherein the network controller communicates with the remote computing system using remote direct access memory (RDMA).

3. The method of claim 1, wherein the network controller fetches the portion of the AI model into at least one of a first memory in the AI offload die, a second memory in the system-in-a-package that is separate from the AI offload die, or a third memory in the compute die.

4. The method of claim 1, wherein,
the network controller is a first network controller;
the system-in-a-package or the compute die comprises a second network controller;
the first network controller is inaccessible by an operating system (OS) executing at the compute die; and
the second network controller is accessible by the OS executing at the compute die.

5. The method of claim 1, wherein:
the AI offload die is communicatively coupled with a plurality of compute dies in the system-in-a-package; and
the method comprises:
identifying a plurality of portions of the AI model, each portion corresponding to one the plurality of compute dies;
using the network controller, fetching the plurality of portions of the AI model from the remote computing system;
communicating each portion of the AI model to its corresponding compute die of the plurality of compute dies; and
using the network controller, synchronizing the AI model inferencing state between the plurality of compute dies and the remote computing system.

6. The method of claim 1, wherein synchronizing the AI model inferencing state includes one or more of,
aligning a token between the compute die and the remote computing system, or
initiating a roll-back of a speculative inference at the compute die based on a token misalignment at the remote computing system.

7. An artificial intelligence (AI) offload die comprising:
a network controller; and
an AI offloading engine configured, during a hybrid inferencing of an AI model by a remote computing system and a compute die, to:
identify a portion of the AI model for use by the compute die;
using the network controller, fetch the portion of the AI model from the remote computing system;
communicate the portion of the AI model to the compute die; and
using the network controller, synchronize AI model inferencing state between the compute die and the remote computing system.

8. The AI offload die of claim 7, wherein the network controller communicates with the remote computing system using remote direct access memory (RDMA).

9. The AI offload die of claim 7, wherein the network controller fetches the portion of the AI model into at least one of a first memory in the AI offload die, a second memory in a system-in-a-package that is separate from the AI offload die, or a third memory in the compute die.

10. The AI offload die of claim 7, wherein:
the network controller is a first network controller;
the compute die or a system-in-a-package comprises a second network controller;
the first network controller is inaccessible by an operating system (OS) executing at the compute die; and
the second network controller is accessible by the OS executing at the compute die.

11. The AI offload die of claim 7, wherein the AI offload die is in a system-in-a-package that also comprises the compute die.

12. The AI offload die of claim 11, wherein:
the system-in-a-package comprises a plurality of compute dies; and
the AI offloading engine,
identifies a plurality of portions of the AI model, each portion corresponding to one the plurality of compute dies;
using the network controller, fetches the plurality of portions of the AI model from the remote computing system;
communicates each portion of the AI model to its corresponding compute die of the plurality of compute dies; and
using the network controller, synchronizes the AI model inferencing state between the plurality of compute dies and the remote computing system.

13. The AI offload die of claim 7, wherein synchronizing the AI model inferencing state includes one or more of,
aligning a token between the compute die and the remote computing system, or
initiating a roll-back of a speculative inference at the compute die based on a token misalignment at the remote computing system.

14. A system-in-a-package, comprising:
a compute die comprising a processor system and an artificial intelligence (AI) accelerator;
a memory; and
an AI offload die, comprising:
a network controller; and
an AI offloading engine configured, during a hybrid inferencing of an AI model by a remote computing system and the compute die, to:
identify a portion of the AI model for use by the compute die;
using the network controller, fetch the portion of the AI model from the remote computing system;
communicate the portion of the AI model to the compute die; and
using the network controller, synchronize AI model inferencing state between the compute die and the remote computing system.

15. The system-in-a-package of claim 14, wherein the AI accelerator in the compute die is one of a neural processing unit (NPU), a tensor processing unit (TPU), or a graphics processing unit (GPU).

16. The system-in-a-package of claim 14, wherein the network controller communicates with the remote computing system using remote direct access memory (RDMA).

17. The system-in-a-package of claim 14, wherein the network controller fetches the portion of the AI model into at least one of a first memory in the AI offload die, a second memory in the system-in-a-package that is separate from the AI offload die, or a third memory in the compute die.

18. The system-in-a-package of claim 14, wherein,
the network controller is a first network controller;
the system-in-a-package or the compute die comprises a second network controller;
the first network controller is inaccessible by an operating system (OS) executing at the compute die; and
the second network controller is accessible by the OS executing at the compute die.

19. The system-in-a-package of claim 14, wherein,
the system-in-a-package comprises a plurality of compute dies; and
the AI offloading engine,
identifies a plurality of portions of the AI model, each portion corresponding to one the plurality of compute dies;
using the network controller, fetches the plurality of portions of the AI model from the remote computing system;
communicates each portion of the AI model to its corresponding compute die of the plurality of compute dies; and
using the network controller, synchronizes the AI model inferencing state between the plurality of compute dies and the remote computing system.

20. The system-in-a-package of claim 14, wherein synchronizing the AI model inferencing state includes one or more of,
aligning a token between the compute die and the remote computing system, or
initiating a roll-back of a speculative inference at the compute die based on a token misalignment at the remote computing system.
